(19) United States
(12) Patent Application Publication
(10) Pub. No.: US 2022/0262369 A1
(43) Pub. Date: Aug. 18, 2022

(54) INFORMATION PROCESSING APPARATUS, INFORMATION PROCESSING METHOD AND STORAGE MEDIUM STORING PROGRAM

(71) Applicant: V-CUBE, INC., Tokyo (JP)

(72) Inventors: Hiroo SOEDA, Tokyo (JP); Takemaru HIRAI, Tokyo (JP); Shigenori SUZUKI, Tokyo (JP); Takashi NAITOU, Tokyo (JP)

(21) Appl. No.: 17/662,661

(22) Filed: May 10, 2022

Related U.S. Application Data
(63) Continuation of application No. PCT/JP2020/020138, filed on May 21, 2020.

(30) Foreign Application Priority Data
Nov. 11, 2019 (JP) 2019-203801

(51) Int. Cl. G10L 17/06; G10L 15/18; G10L 15/26; G10L 25/03; G10L 17/02

(52) U.S. Cl. CPC G10L 17/06; G10L 15/18; G10L 17/02; G10L 25/03; G10L 15/26

(57) ABSTRACT

An information processing apparatus includes a display controller that displays a plurality of different display character strings on a display part displaying a video, a voice processor that recognizes voice inputted to a predetermined microphone, a selector that selects a display character string that is relatively close to an input character string indicated by the voice recognized by the voice processor from the plurality of display character strings, and a processing executer that executes processing that corresponds to the display character string selected by the selector and affects the video.

### CROSS-REFERENCE TO RELATED APPLICATIONS

The present application is a continuation application of International Application number PCT/JP2020/20138, filed on May 21, 2020, which claims priority under 35 U.S.C. § 119(a) to Japanese Patent Application No. 2019-203801, filed on Nov. 11, 2019. The contents of these applications are incorporated herein by reference in their entirety.

### BACKGROUND OF THE INVENTION

The present invention relates to an information processing apparatus, an information processing method, and a storage medium storing a program that can receive an operation by voice.

A conventional video conference system has been known to recognize voice inputted during a video conference and to perform an operation on the basis of the recognized voice (for example, see Japanese Unexamined Patent Application Publication No. 2008-252455).

In the conventional video conference system, a user of the video conference system needs to memorize commands that can be inputted by voice. Therefore, there is a problem that the user tends to utter a voice command different from the commands that can be inputted, resulting in that the user cannot perform an intended operation.

### BRIEF SUMMARY OF THE INVENTION

The present disclosure focuses on this point, and an object of the present disclosure is to facilitate correct operation of an apparatus by voice.

A first aspect of the present disclosure provides an information processing apparatus including a display controller that displays a plurality of different display character strings on a display part displaying a video, a voice processor that recognizes voice inputted to a predetermined microphone, a selector that selects a display character string that is relatively close to an input character string indicated by the voice recognized by the voice processor from the plurality of display character strings, and a processing executer that executes processing that corresponds to the display character string selected by the selector and affects the video.

A second aspect of the present disclosure provides an information processing method including the steps, executed by a computer, of displaying a video on a display part, displaying a plurality of different display character strings while displaying the video on the display part, recognizing voice inputted to a predetermined microphone, selecting a display character string closest to an input character string indicated by the recognized voice, from the plurality of display character strings, and executing processing that corresponds to the selected display character string and affects the video.

A third aspect of the present disclosure provides a non-transitory storage medium for storing a program for causing a computer to function as a display controller that displays a plurality of different display character strings on a display part displaying a video, a voice processor that recognizes voice inputted to a predetermined microphone, a selector that selects a display character string closest to an input character string indicated by the voice recognized by the voice processor, from the plurality of display character strings, and a processing executer that executes processing that corresponds to the display character string selected by the selector and affects the video.

### BRIEF DESCRIPTION OF THE DRAWINGS

FIG. 1 illustrates an overview of a communication system.

FIG. 2 schematically shows a configuration of an information processing apparatus.

FIG. 3 is a block diagram showing the configuration of the information processing apparatus.

FIG. 4 shows an example of a table stored in a memory.

FIGS. 5A and 5B show examples of a screen displayed on a display by a display controller.

FIGS. 6A and 6B show examples of a screen for modifying a display character string.

FIG. 7 shows a screen after a display character string is modified.

FIG. 8 shows display character string candidates displayed when it is determined that “light” is frequently used in the environment identified by the selector.

FIG. 9 is a flowchart showing a display character string modification process performed by a controller.

### DETAILED DESCRIPTION OF THE INVENTION

Hereinafter, the present invention will be described through exemplary embodiments of the present invention, but the following exemplary embodiments do not limit the invention according to the claims, and not all of the combinations of features described in the exemplary embodiments are necessarily essential to the solution means of the invention.

### [Overview of Communication System S]

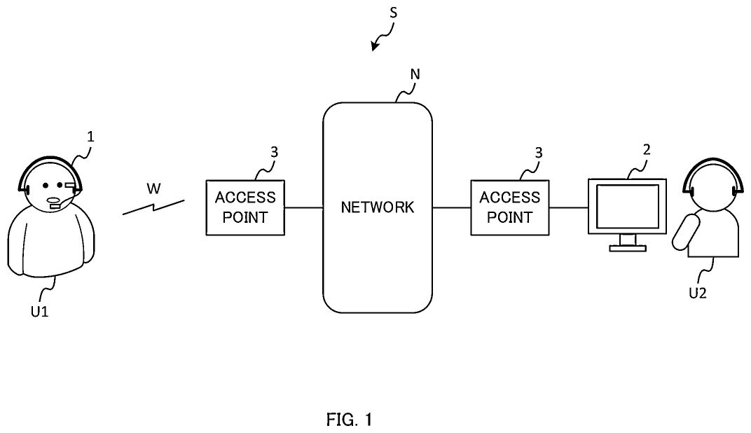

FIG. 1 illustrates an overview of a communication system S. The communication system S is a system for video and voice communication, and includes an information processing apparatus 1 and an information processing apparatus 2. The information processing apparatus 1 and the information processing apparatus 2 can transmit and receive video and voice via an access point 3 and a network N.

The information processing apparatus 1 is a device used by a user U1, and is smart glasses that can be worn on the head by user U1 to be used, for example. The information processing apparatus 2 is a computer used by a user U2. The information processing apparatus 2 may be smart glasses similar to the information processing apparatus 1. The access point 3 is a Wi-Fi (registered trademark) router for the information processing apparatus 1 and the information processing apparatus 2 to wirelessly access the network N, for example.

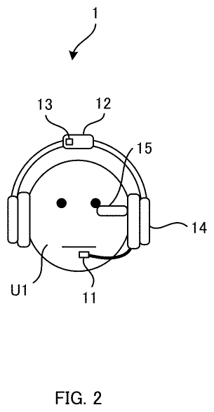

FIG. 2 schematically shows a configuration of the information processing apparatus 1. The information processing apparatus 1 includes a microphone 11, a camera 12, a light 13, a speaker 14, and a display 15.

The microphone 11 collects sound from surroundings of the information processing apparatus 1. The microphone 11 receives the voice inputted from the user U1, for example. Sound data collected by the microphone 11 is transmitted to the information processing apparatus 2 via the network N.

The camera 12 captures an image of the surroundings of the information processing apparatus 1. For example, the camera 12 generates an image of an area that the user U1 is viewing. The captured image generated by the camera 12 is transmitted to the information processing apparatus 2 via the network N.

The light 13 emits light to illuminate the surroundings of the information processing apparatus 1. The light 13 can be switched between a light-on state and a light-off state by an operation of the user U1, for example.

The speaker 14 is attached to an ear portion of the user U1 and emits sound. The speaker 14 outputs the voice of the user U2 transmitted from the information processing apparatus 2, for example.

The display 15 is provided at a position where it can be seen by the user U1, and is a display part that displays various types of information. The display 15 displays the video (for example, a face image of the user U2) transmitted from the information processing apparatus 2, for example. The display 15 may display the captured image generated by the camera 12. Further, the display 15 displays display character strings that are text information for the user U1 to perform various operations related to the information processing apparatus 1, together with the video that includes at least one of the videos transmitted from the information processing apparatus 2 and the captured image generated by the camera 12.

The information processing apparatus 1 is provided with devices such as the microphone 11, the camera 12, the light 13, the speaker 14, the display 15, and the like which are used for the user U1 to perform communication with the user U2 using the video and voice, in a manner whereby the user U1 can wear the information processing apparatus 1 on the head. In addition, when the voice corresponding to the display character string displayed on the display 15 is inputted to the microphone 11, the information processing apparatus 1 performs processing corresponding to the inputted voice. Therefore, the user U1 can perform various operations without using his/her hands by uttering the voice command corresponding to the text information displayed on the display 15, such that the user U1 can communicate the surrounding situation to user U2 and receive instructions from the user U2 by using the video and voice while working with both hands.

### [Configuration of Information Processing Apparatus 1]

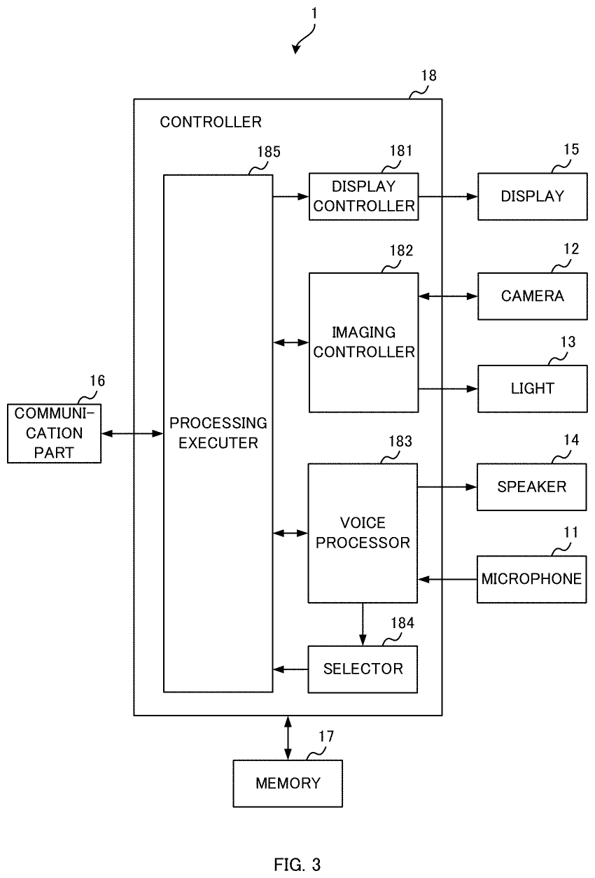

FIG. 3 is a block diagram showing the configuration of the information processing apparatus 1. The information processing apparatus 1 includes a communication part 16, a memory 17, and a controller 18 in addition to the microphone 11, the camera 12, the light 13, the speaker 14, and the display 15 shown in FIG. 2.

The communication part 16 is a communication interface for transmitting and receiving the video and voice to and from the information processing apparatus 2 via the access point 3 and the network N, and includes a wireless communication controller of Wi-Fi or Bluetooth (registered trademark), for example.

The memory 17 is a storage medium for storing various types of data, and includes a Read Only Memory (ROM) and a Random Access Memory (RAM), for example. The memory 17 stores a program executed by the controller 18.

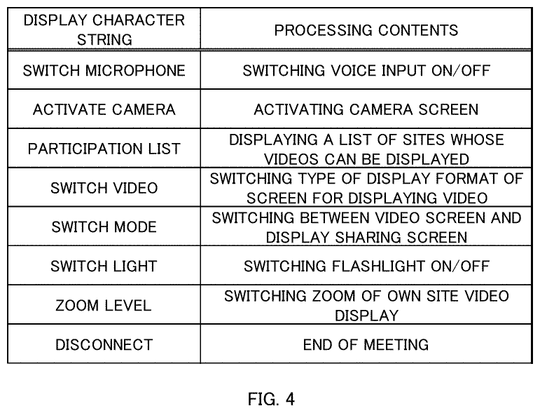

Further, the memory 17 stores a plurality of display character strings to be displayed on the display 15 in association with a plurality of processing contents executed by the controller 18. FIG. 4 shows an example of a table stored in the memory 17. The table shown in FIG. 4 shows contents of the processing to be executed by the controller 18 when “switch microphone,” “activate camera,” “participation list,” “switch video,” “switch mode,” “switch light,” “zoom level,” and “disconnect” displayed on the display 15 as the display character strings are selected.

The controller 18 is a Central Processing Unit (CPU), for example. The controller 18 functions as a display controller 181, an imaging controller 182, a voice processor 183, a selector 184, and a processing executer 185 by executing the program stored in the memory 17.

The display controller 181 displays various types of information on the display 15. For example, the display controller 181 displays the plurality of different display character strings on the display 15 while displaying the video.

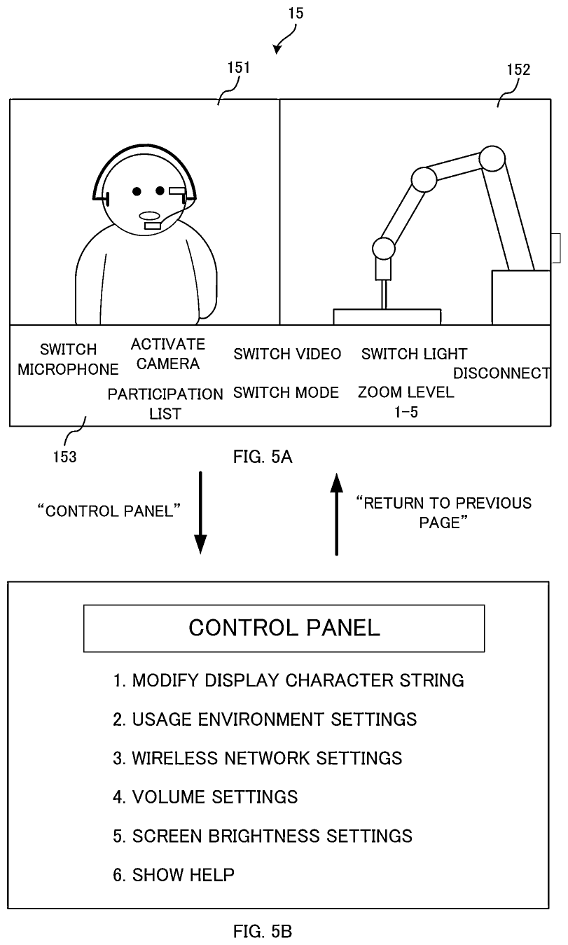

FIGS. 5A and 5B show examples of a screen displayed on the display 15 by the display controller 181. FIG. 5A shows an example of a screen displayed on the display 15 while the user U1, who uses the information processing apparatus 1, is having a meeting with the user U2, who uses the information processing apparatus 2, while watching the video. The video of the user U2 is displayed in an area 151, the video captured by the camera 12 is displayed in an area 152, and the plurality of display character strings shown in FIG. 4 are displayed in an area 153.

FIG. 5B shows a screen of a control panel which is an example of another screen displayed on the display 15. The control panel is a screen for receiving various settings that affect the operation of the information processing apparatus 1. The display controller 181 switches to the screen of the control panel shown in FIG. 5B when the user U1 utters the voice command “control panel” while the screen shown in FIG. 5A that displays the display character strings is displayed on the display 15. In addition, the display controller 181 switches to the screen shown in FIG. 5A when the user U1 utters the voice command “return to previous page” while the control panel is displayed.

The user U1 can cause the information processing apparatus 1 to execute corresponding processing by reading the character string displayed on the control panel or the number displayed in association with the character string. The user U1 can modify the display character string displayed on the screen of FIG. 5A by uttering the voice command “modify display character string,” for example. Details of the processing of modifying the display character string will be described later.

The imaging controller 182 controls the camera 12 and the light 13. The imaging controller 182 causes the camera 12 to execute imaging processing to generate a captured image, and acquires the generated captured image. The imaging controller 182 transmits the acquired captured image to the information processing apparatus 2 via the processing executer 185, or displays the captured image on the display 15 via the display controller 181. In addition, the imaging controller 182 turns on or off the light 13 on the basis of an instruction from the processing executer 185.

The voice processor 183 performs various types of processing related to the voice. The voice processor 183 outputs the voice received from the information processing apparatus 2 via the processing executer 185 to the speaker 14, for example. Further, the voice processor 183 recognizes the voice inputted from the microphone 11 to identify an input character string included in the inputted voice. When the voice processor 183 detects a character string included in a word dictionary by referring to the word dictionary stored in the memory 17, the voice processor 183 identifies the detected character string as the input character string, for example. The voice processor 183 notifies the selector 184 about the identified input character string.

The selector 184 selects a display character string relatively close to the input character string indicated by the voice recognized by the voice processor 183, from the plurality of display character strings displayed on the screen shown in FIG. 5A. Specifically, the selector 184 compares the input character string notified from the voice processor 183 with each of the plurality of display character strings, and selects the closest display character string. The selector 184 notifies the processing executer 185 about the selected display character string.

If the selector 184 determines that the input character string notified from the voice processor 183 is not similar to any of the plurality of display character strings, the selector 184 does not select a display character string and does not notify the processing executer 185 about the display character string. If the selector 184 cannot recognize the display character string even though the input character string is notified from the voice processor 183, the selector 184 may display the fact that the display character string cannot be recognized on the display 15, via the display controller 181.

The processing executer 185 executes various types of processing, including processing that corresponds to the display character string selected by the selector 184 and affects the video. The processing executer 185 executes an operation of processing content corresponding to the display character string selected by the selector 184 by referring to the table shown in FIG. 4, for example.

When the display character string “switch microphone” is selected, the processing executer 185 switches between a state in which the voice can be inputted from the microphone 11 and a state in which the voice cannot be inputted. When the display character string “activate camera” is selected, the processing executer 185 activates the camera 12 to cause the camera 12 to start generating the captured image.

When the display character string “participation list” is selected, the processing executer 185 displays a list of sites whose videos can be displayed. The site whose video can be displayed is set by the user who uses the communication system S, and a place where the user U2 is located is set as the site whose video can be displayed in the present embodiment.

When the display character string “switch video” is selected, the processing executer 185 switches the type of display format of the screen for displaying the video as shown in FIG. 5A. For example, as shown in FIG. 5A, the processing executer 185 switches among (i) a display format that displays a plurality of videos captured at a plurality of sites, (ii) a display format that displays only a video captured at another site (for example, a site of the user U2), and (iii) a display format that displays only a video captured at a site where the information processing apparatus 1 is used (for example, a site of the user U1).

When the display character string “switch mode” is selected, the processing executer 185 switches between (i) a display format that displays the video captured at each site and (ii) a display format that displays a screen of the computer at each site. When the display character string “switch light” is selected, the processing executer 185 switches between a state where the light 13 is turned on and a state where the light 13 is turned off

When the display character string “zoom level” is selected, the processing executer 185 switches a zoom amount used when the camera 12 captures an image. When the display character string “disconnect” is selected, the processing executer 185 cuts off the video and voice communication with another site.

### [Modification Processing of Display Character String]

As described above, the information processing apparatus 1 executes the processing corresponding to the display character string closest to the input character string identified by the voice generated by the user U1, among the plurality of display character strings displayed on the display 15. However, depending on the location where the information processing apparatus 1 is used, conversations of people in the surroundings may easily include character strings identical or similar to the display character strings, and in such cases, a display character string contrary to the intention of the user U1 using the information processing apparatus 1 may be selected.

Therefore, the information processing apparatus 1 is configured to be able to modify each of the plurality of display character strings displayed on the display 15. Specifically, the selector 184 receives an operation of selecting one type of processing content among the plurality of types of processing content, and modifies the display character string stored in the memory 17 in association with the selected one type of processing content. More specifically, when “modify display character string” is selected on the control panel shown in FIG. 5B, the selector 184 notifies the display controller 181 to display a screen for modifying the display character string.

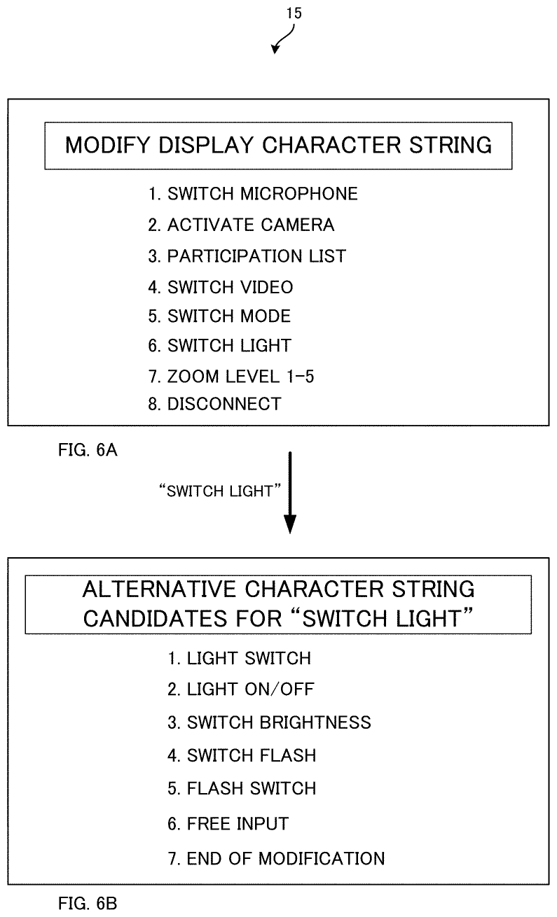

FIGS. 6A and 6B show examples of the screen for modifying the display character string. FIG. 6A is a screen for selecting the display character string to be modified. FIG. 6A shows a list of a plurality of display character strings. When the selector 184 identifies that a voice command corresponding to any of the plurality of display character strings displayed is inputted, the selector 184 causes the display controller 181 to display the screen shown in FIG. 6B that displays character string candidates after the modification of the identified display character string.

As shown in FIG. 6B, the display controller 181 displays the plurality of display character string candidates associated with the one processing content on the display 15. Then, the selector 184 modifies the display character string associated with the one processing content to one display character string candidate selected from the plurality of display character string candidates.

In the example shown in FIG. 6B, “light switch,” “light on/off,” “switch brightness,” “switch flash,” and “flash switch” are displayed as candidates of the display character string to perform the processing of switching the light 13 on and off. Further, FIG. 6B includes “free input” that can be selected when the user U1 wants to use a freely determined character string as the display character string and “end of modification” that can be selected when the user wants to finish modifying the character string.

For example, if “switch microphone” and “switch light” are likely to be misrecognized in the plurality of display character strings displayed on the screen shown in FIG. 5A, the user U1 can utter “light switch” while the screen shown in FIG. 6B is displayed to modify the character string to be uttered to switch the light 13 on and off from “switch light” to “light switch.” When the selector 184 identifies that the character string “end of modification” is inputted while the screen of FIG. 6B is displayed, the selector 184 ends the processing of modifying the display character string and causes the display controller 181 to display the screen with the plurality of display character strings.

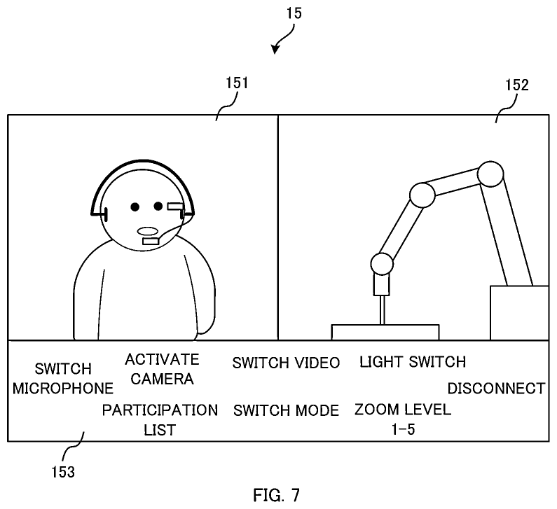

FIG. 7 shows a screen after the display character string is modified. In FIG. 7, the display character string “light switch” is displayed at a position where the display character string “switch light” was displayed in FIG. 5A. By having the display character string being modified in this manner, the user U1 whose utterance “switch light” was frequently misrecognized becomes less likely to be misrecognize when he/she switches the state of the light 13.

The selector 184 may identify an environment where the information processing apparatus 1 is used, and select a display character string from the plurality of display character string candidates on the basis of an identified environment. For example, the selector 184 determines whether the environment is one in which a character string that is identical or similar to the character string contained in any of the plurality of display character strings is frequently uttered, on the basis of the character string contained in the inputted voice when the plurality of display character strings are not displayed.

If the selector 184 determines that the environment is one in which a character string that is identical or similar to the character string contained in any of the plurality of display character strings is frequently uttered, the selector 184 selects, as the display character string, a display character string candidate among the plurality of display character string candidates that has a relatively low degree of similarity to the character string that is frequently used in the identified environment. For example, if the selector 184 determines that there is a person named “Light” in the place where the information processing apparatus 1 is used and that a frequency of the character string “light” being uttered is equal to or above a threshold value, the selector 184 selects “switch flash” as the display character string that does not contain “light.”

By having the selector 184 operate in this manner, the display controller 181 (i) selects, from the plurality of display character string candidates, the plurality of display character string candidates having a relatively low similarity to the character string with the identical or similar string being uttered with a high frequency on the basis of a character string included in the voice inputted in a state where the plurality of display character strings are not displayed on the display 15, and (ii) displays the selected plurality of display character string candidates as the plurality of display character strings. The selector 184 and the display controller 181 operate in such a way that a probability of misrecognition of the display character string in the environment where the information processing apparatus 1 is used is reduced. In addition, it is possible to prevent a character string having a low frequency of being uttered in a usage environment from being deleted from the display character string, while also preventing a character string that is frequently uttered in the usage environment from being used as the display character string.

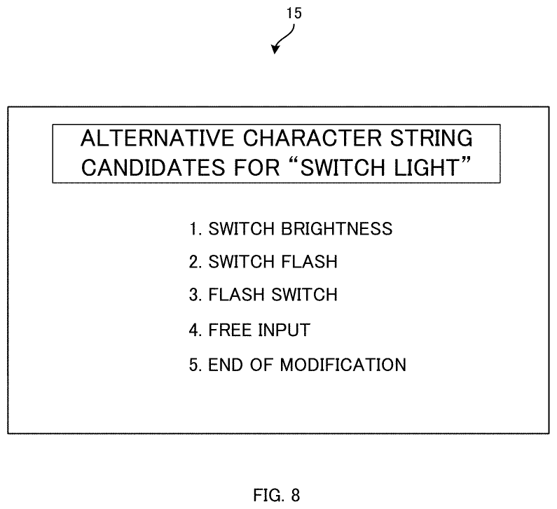

The selector 184 may instruct the display controller 181 to display, on the display 15, one or more display character string candidates having a relatively low similarity to the character string that is frequently used in the identified environment. FIG. 8 shows the display character string candidates displayed when it is determined that “light” is frequently used in the environment identified by the selector 184. Unlike FIG. 6B, FIG. 8 shows no display character string candidates containing “light.” The selector 184 selects the display character string candidate selected from one or more display character string candidates displayed on the screen as shown in FIG. 8 on the display 15, as the display character string. By having the selector 184 operate in this manner, the user U1 can select a display character string with a low probability of being misrecognized in the environment where the information processing apparatus 1 is used.

The display controller 181 may display a plurality of environment candidates for identifying the environment on the display 15, and the selector 184 may identify one environment candidate selected from the plurality of environment candidates as the environment where the information processing apparatus 1 is to be used. For example, the display controller 181 causes the display 15 to display the plurality of environment candidates indicating names of industries in which the information processing apparatus 1 is to be used. The names of industries are the petrochemical industry, semiconductor industry, automobile industry, and the like, for example. Further, the display controller 181 may display the plurality of environment candidates indicating a purpose of use of the information processing apparatus 1, on the display 15. The purpose of use is for disaster prevention-related work, work in factories, work at construction sites, and the like, for example.

In this case, the memory 17 may store the plurality of display character string candidates recommended to be used in association with each of the plurality of environment candidates. The selector 184 may select the plurality of display character string candidates stored in the memory 17 in association with the environment candidates selected from the plurality of environment candidates, and may instruct the display controller 181 to display the selected plurality of display character string candidates on a screen shown in FIG. 6B or the like.

Further, the memory 17 may store the plurality of display character strings to be displayed on the screen of FIG. 5A in a default state, associated with each of the plurality of environment candidates. In this case, the display controller 181 displays the plurality of display character strings stored in the memory 17 associated with the environment candidates identified by the selector 184 in the area 153 of the display 15. The display controller 181 displays on the display 15 the display character string suitable for the environment in which the information processing apparatus 1 is used in this manner, thereby reducing the probability of misrecognition without the user U1 having to go through the modification processing.

When the selector 184 receives an operation of modifying the display character string to another display character string on the screen shown in FIG. 6B, the selector 184 may output an alarm if it is determined that this other display character string is similar to the character string frequently used in the identified environment. For example, when “switch light” is selected in an environment where “light” is frequently used, the selector 184 instructs the display controller 181 to display a warning “there is a possibility of misrecognition” on the display 15. By having the selector 184 operate in this manner, it becomes difficult for the user U1 to select a display character string having a high probability of causing misrecognition in the environment where the information processing apparatus 1 is used.

### [Processing of the Controller 18]

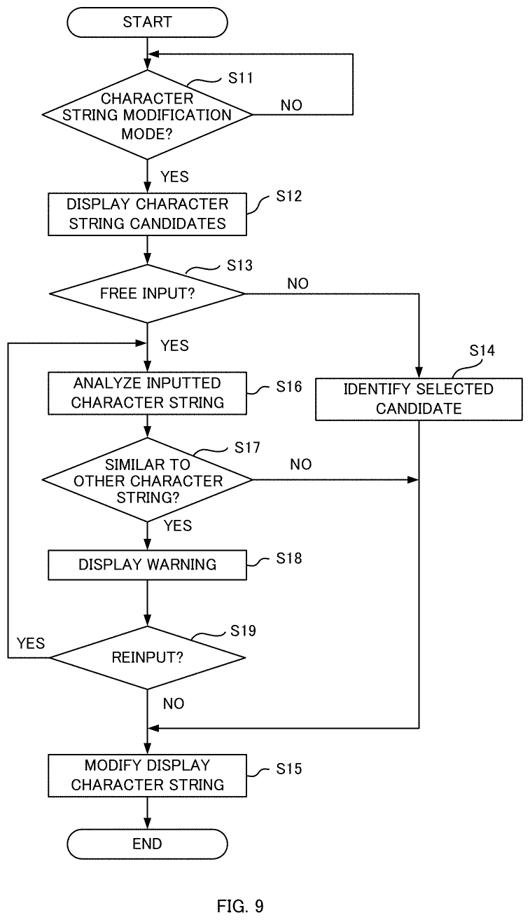

FIG. 9 is a flowchart showing a display character string modification process performed by the controller 18. The flowchart shown in FIG. 9 starts from a state where the control panel shown in FIG. 5B is displayed.

The selector 184 monitors whether or not “modify display character string” is selected on the control panel (step S11). If the selector 184 determines that “modify display character string” is selected, the selector 184 displays the plurality of display character string candidates as shown in FIG. 6B (step S12).

The selector 184 monitors whether or not “free input” is selected on the screen shown in FIG. 6B (step S13). If the selector 184 determines that “free input” is not selected and any one of the plurality of display character string candidates is selected (NO in step S13), the selector 184 identifies the selected display character string candidate (step S14), and modifies the display character string (step S15).

If the selector 184 determines that “free input” is selected in step S13 (YES in step S13), the selector 184 analyzes the inputted character string (step S16). If the selector 184 determines that the inputted character string is not similar to any of the plurality of display character strings corresponding to other processing contents (NO in step S17), the selector 184 modifies the inputted character string to a new display character string (step S15).

On the other hand, if the selector 184 determines in step S17 that the inputted character string is similar to any of the plurality of display character strings corresponding to said other processing content (YES in step S17), the selector 184 instructs the display controller 181 to display a warning on the display 15 to notify the user U1 that there is a similar display character string (step S18).

If the character string is inputted again within a predetermined time after the warning is displayed (YES in step S19), the selector 184 returns to step S16 and analyzes the inputted character string. If the character string is not inputted again within the predetermined time after the warning is displayed (NO in step S19), the selector 184 modifies the inputted character string to a new display character string (step S15).

### [Effects of Information Processing Apparatus 1]

As described above, the information processing apparatus 1 includes the display controller 181 that displays the plurality of different display character strings on the display 15 displaying the video, the selector 184 that selects the display character string that is relatively close to the inputted character string indicated by the voice inputted to the microphone 11, and the processing executer 185 that performs the processing that corresponds to the display character string selected by the selector 184 and affects the video. Since the information processing apparatus 1 has such a configuration, the user U1 who uses the information processing apparatus 1 can perform a desired operation by uttering the display character string, and so the apparatus can be operated correctly by voice.

Further, the selector 184 receives an operation of selecting one type of processing content from the plurality of types of processing content, and modifies the display character string stored in the memory 17 associated with the selected one type of processing content. By having the selector 184 operate in this manner, the user U1 or the information processing apparatus 1 can modify the display character string displayed on the display 15 to a character string that is hard to be misrecognized in the environment where the information processing apparatus 1 is used, and so the operation of the information processing apparatus 1 by voice can be performed more correctly.

The present invention is explained on the basis of the exemplary embodiments. The technical scope of the present invention is not limited to the scope explained in the above embodiments and it is possible to make various changes and modifications within the scope of the invention. For example, all or part of the apparatus can be configured with any unit which is functionally or physically dispersed or integrated. Further, new exemplary embodiments generated by arbitrary combinations of them are included in the exemplary embodiments of the present invention. Further, effects of the new exemplary embodiments brought by the combinations also have the effects of the original exemplary embodiments.

What is claimed is:

1. An information processing apparatus comprising:
a display controller that displays a plurality of different display character strings on a display part displaying a video;
a voice processor that recognizes voice inputted to a predetermined microphone;
a selector that selects a display character string that is relatively close to an input character string indicated by the voice recognized by the voice processor from the plurality of display character strings; and
a processing executer that executes processing that corresponds to the display character string selected by the selector and affects the video.

2. The information processing apparatus according to claim 1, wherein
the display controller (i) selects, from a plurality of display character string candidates, a plurality of display character string candidates having a relatively low similarity to a character string for which an identical or similar character string is uttered with a high frequency, on the basis of a character string included in the voice inputted in a state where the plurality of display character strings are not displayed on the display part, and (ii) displays the selected plurality of display character string candidates as the plurality of display character strings.

3. The information processing apparatus according to claim 1, further comprising:
a memory that stores the plurality of display character strings and a plurality of types of processing content in association with each other, wherein
the selector receives an operation of selecting one type of processing content from the plurality of types of processing content, and modifies the display character string stored in the memory in association with the selected one type of processing content.

4. The information processing apparatus according to claim 3, wherein
the display controller causes the display part to display a plurality of display character string candidates associated with the one type of processing content, and
the selector modifies the display character string associated with the one type of processing content to one display character string candidate selected from the plurality of display character string candidates.

5. The information processing apparatus according to claim 1, wherein
the selector identifies an environment where the information processing apparatus is used, and selects the display character string from a plurality of display character string candidates on the basis of the identified environment.

6. The information processing apparatus according to claim 5, wherein
the selector selects, as the display character string, the display character string candidate having a relatively low similarity to a character string that is frequently used in the identified environment, among the plurality of display character string candidates.

7. The information processing apparatus according to claim 5, wherein
the selector causes the display part to display, among the plurality of display character string candidates, one or more display character string candidates having a relatively low similarity to a character string that is frequently used in the identified environment, and selects the display character string candidate selected from the one or more display character string candidates displayed on the display part as the display character string.

8. The information processing apparatus according to claim 5, wherein
the selector receives an operation of modifying the display character string to another display character string, and outputs an alarm when it is determined that the other display character string is similar to a character string used in the identified environment.

9. The information processing apparatus according to claims 8, wherein
the display controller displays the alarm on the display part if “light switch” is selected as the display character string in an environment where “light” is frequently used.

10. The information processing apparatus according to claim 5, wherein
the display controller causes the display part to display a plurality of environment candidates for identifying an environment, and
the selector identifies one environment candidate selected from the plurality of environment candidates as an environment where the information processing apparatus is used.

11. The information processing apparatus according to claim 1, wherein
the processing executer switches between a state where voice can be inputted and a state where voice cannot be inputted from the microphone, if “switch microphone” is selected from the plurality of display character strings.

12. The information processing apparatus according to claim 1, further comprising:
a camera, wherein
the processing executer activates the camera to cause the camera to start generating a captured image, if “activate camera” is selected from the plurality of display character strings.

13. The information processing apparatus according to claim 1, wherein
the processing executer displays a list of sites that can display a video of a user who uses another information processing apparatus that can communicate with the information processing apparatus, if “participation list” is selected from the plurality of display character strings.

14. The information processing apparatus according to claim 13, wherein
the processing executer switches among (i) a display format that displays a plurality of videos captured at a plurality of sites including a site where the information processing apparatus is used, (ii) a display format that displays only a video captured at a site other than the site where the information processing apparatus is used, and (iii) a display format that displays only a video captured at the site where the information processing apparatus is used, if “switch video” is selected from the plurality of display character strings.

15. The information processing apparatus according to claim 12, wherein
the processing executer switches between a display format that displays a video captured at each site and a display format that displays a screen of a computer at each site, if “switch mode” is selected from the plurality of display character strings.

16. The information processing apparatus according to claim 1, wherein
the selector selects a display character string that does not contain “light” if the selector determines that there is a person named “light” in a place where the information processing apparatus is used and a frequency of the character string “light” being uttered is equal to or greater than a threshold value.

17. The information processing apparatus according to claim 1, wherein
the information processing apparatus is a spectacle-shaped device that is worn by a user on a head and used by the user.

18. An information processing method comprising the steps, executed by a computer, of:
displaying a video on a display part;
displaying a plurality of different display character strings while displaying the video on the display part;
recognizing voice inputted to a predetermined microphone;
selecting a display character string closest to an input character string indicated by the recognized voice, from the plurality of display character strings; and
executing processing that corresponds to the selected display character string and affects the video.

19. A non-transitory storage medium for storing a program for causing a computer to function as:
a display controller that displays a plurality of different display character strings on a display part displaying a video;
a voice processor that recognizes voice inputted to a predetermined microphone;
a selector that selects a display character string closest to an input character string indicated by the voice recognized by the voice processor, from the plurality of display character strings; and
a processing executer that executes processing that corresponds to the display character string selected by the selector and affects the video.
